(19) United States
(12) Patent Application Publication
(10) Pub. No.: US 2007/0078791 A1
(43) Pub. Date: Apr. 5, 2007

(54) Asset management system

(75) Inventors: Bhavin Vyas, Peoria, IL (US); Jay Dawson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/239,243

(22) Filed: Sep. 30, 2005

(51) Int. Cl. G06F 17/00

(52) U.S. Cl. 705/400

(57) ABSTRACT

An asset management system is provided. The system may include one or more data collection devices configured to monitor one or more operating conditions of a work machine. The system may also include a processor configured to receive data from the one or more data collection devices and predict a cost to maintain the work machine in the future based on the data from the one or more data collection devices. The processor may also be configured to compare the predicted cost to maintain the work machine to a depreciated value of the work machine to determine a time for replacement of the work machine.

### TECHNICAL FIELD

The present disclosure is directed to an asset management system and, more particularly, to an asset management system based on work machine data acquisition.

### BACKGROUND

Over time, work machines have become more and more technologically sophisticated. The evolution of computing technology, among other things, has spawned the development of better performing work machines by facilitating more control of work machine operating systems. Improved control may be enabled, in some cases, by monitoring the operating parameters of a system or component in “real-time.” Such monitoring may enable a system to respond in a precise and virtually immediate manner to maintain operating parameters to desired specifications.

Work machine owners may be concerned with various aspects of work machine operation, such as machine performance, operator conduct (e.g., abuse, productivity, etc.), efficiency, work machine health, etc. In particular, the cost to maintain a work machine can be a major economic factor in asset management. An expected cost to maintain a work machine may be compared to depreciated value of the machine to determine when to replace the work machine.

The same or similar types of monitoring equipment that are used to regulate performance of a work machine may also be used to record operating conditions data that may be used to monitor the various aspects of work machine operation mentioned above. Data acquisition such as this may be used to determine the expected lifespan of work machine parts and/or components in view of how they have been or are currently being used. Systems have been developed that make use of such data acquisition in determining when to replace parts of a work machine. For example, U.S. Pat. No. 6,907,384 to Adachi et al. (“the '384 patent”), discloses determining, based on operation data, an actual repair/replacement time interval of each part of a construction machine.

While the '384 patent may disclose determining a repair/replacement time interval of each part of a construction machine, the '384 patent does not disclose determining a replacement time interval of the machine as a whole. Armed with this information, an owner of a fleet of work machines would be much better prepared to make cost-effective decisions for its business. Work machines can represent the most valuable assets of a business, and making the correct decision on repairing versus replacing a work machine can directly affect the business's bottom line.

The present disclosure is directed to overcoming one or more of the problems set forth above.

### SUMMARY OF THE INVENTION

In one aspect, the present disclosure is directed to an asset management system. The system may include one or more data collection devices configured to monitor one or more operating conditions of a work machine. The system may also include a processor configured to receive data from the one or more data collection devices and predict a cost to maintain the work machine in the future based on the data from the one or more data collection devices. The processor may also be configured to compare the predicted cost to maintain the work machine to a depreciated value of the work machine to determine a time for replacement of the work machine.

In another aspect, the present disclosure is directed to a method of determining a time for replacement of a work machine. The method may include monitoring one or more operating conditions of the work machine and collecting data for the one or more operating conditions. In addition, the method may include predicting a cost to maintain the work machine in the future based on the collected data. The method may further include comparing the predicted cost to maintain the work machine to a depreciated value of the work machine to determine a time for replacement of the work machine.

### BRIEF DESCRIPTION OF THE DRAWINGS

FIG. 1 is a diagrammatic illustration of an asset management system according to an exemplary disclosed embodiment.

FIG. 2 is a block diagram representation of an asset management system according to an exemplary disclosed embodiment.

FIG. 3 is a graph illustrating maintenance costs and depreciation over time.

### DETAILED DESCRIPTION

Reference will now be made in detail to the drawings. Wherever possible, the same reference numbers will be used throughout the drawings to refer to the same or like parts.

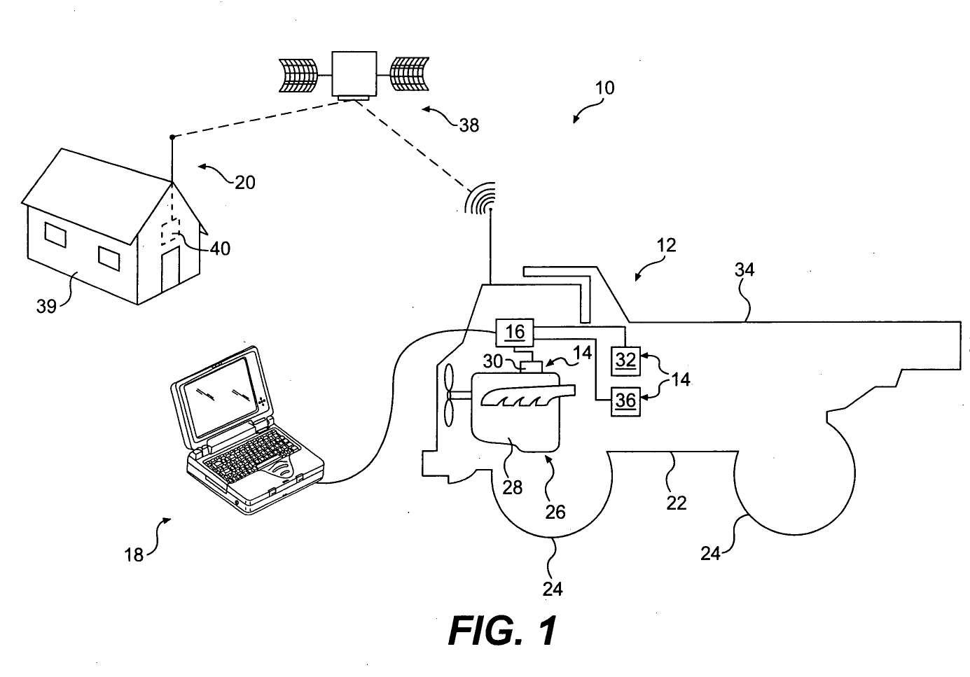

FIG. 1 shows an asset management system 10. System 10 may include a work machine 12. System 10 may also include data collection devices 14, a controller 16, and a means for offloading data from work machine 12. Such means may include, for example, a hardware interface device 18 or an over-the-air transmission receiving device 20.

Work machine 12 may include a frame 22, one or more traction devices 24, and a power source 26. Although work machine 12 is shown as a truck, work machine 12 could be any type of machine. Accordingly, traction devices 24 may be any type of traction devices, such as, for example, wheels, as shown in FIG. 1, tracks, belts, or any combinations thereof.

Power source 26 may include any type of power source. Power source 26 is illustrated as an internal combustion engine 28. Power source 26 may include any type of internal combustion engine, such as gasoline engines, diesel engines, natural gas engines, etc. Although power source 26 is illustrated as an internal combustion engine, alternatively, power source 26 could be an electrical power source, such as a battery. Power source 26 could also include a hybrid power system, combining, for example, an internal combustion engine with a battery.

Data collection devices 14 may include any kind of sensors or other types of monitoring equipment suitable for monitoring one or more operating conditions of work machine 12. In one aspect, data collection devices 14 may be configured to monitor one or more operating parameters of work machine 12. For example, system 10 may include an engine monitoring device 30 configured to monitor one or more operating parameters of engine 28. Exemplary engine operating parameters that may be monitored by engine monitoring device 30 include engine hours (i.e., the amount of time the engine runs), engine speed, idle time, engine load, etc.

Data collection devices 14 may also include other equipment for monitoring other operating parameters of work machine 12. For example, work machine 12 may include a work implement sensor 32. Work implement sensor 32 could be any type of sensor for monitoring the operation of a work tool, such as a bucket, blade, claw, etc. As shown in FIG. 1, work implement sensor 32 may be configured to monitor the operation of a dump body 34 of work machine 12. Work implement sensor 32 may be configured to monitor the number of times and/or the speed at which dump body 34 is raised and lowered. Data collection devices 14 may also include other equipment for monitoring other aspects of work machine 12, such as transmissions, suspension, and actuators, as well as temperatures and/or pressures of various fluids, such as engine oil, hydraulic fluid, coolant, etc. For example, pressure within shocks or struts of work machine 12 may be monitored to determine a payload being transported by a hauling vehicle, such as work machine 12. Payload data may provide insight into wear and tear on work machine 12.

Work machine 12 may also be equipped with one or more atmospheric sensors 36 to monitor other types of operating conditions of work machine 12. For example, atmospheric conditions, such as temperature, humidity, precipitation, etc. may be monitored. Other atmospheric conditions may also be monitored, such as dust and other particulates in the air.

Other operating conditions that may be monitored may include geographic parameters, such as information about geographic location. For example, work machine 12 may be equipped with a positioning device or system (not shown). One such system may be configured for tracking work machine.12 via a global positioning system (GPS). Other geographic parameters may also be monitored such as elevation at a worksite and/or incline of surfaces over which work machine 12 may travel.

It should also be noted that more than one of these types of operating conditions may be monitored. For example, work machine 12 may be equipped to monitor any combination of operating parameters, geographic parameters, and atmospheric conditions.

Controller 16 may be located anywhere on work machine 12 and may include any type of processing device suitable for receiving data from data collection devices 14. Controller 16 may also be configured to facilitate offloading of the data to a location remote from work machine 12.

In addition to controller 16, system 10 may include means for offloading data from work machine 12. Such means may include a hardware interface device 18 configured to interface with controller 16 or directly with data collection devices 14 to download or otherwise retrieve data from work machine 12. For example, hardware interface device 18 may include a laptop or personal digital assistant (PDA) configured to “plug in” to work machine 12.

Alternatively or additionally, system 10 may include an over-the-air transmission receiving device 20 configured to retrieve data from work machine 12 via “wireless” communication. For example, over-the-air transmission receiving device 20 may include a laptop or PDA configured to retrieve data from work machine 12 via a wireless network or Internet connection. In other embodiments, system 10 may be configured to retrieve data from work machine 12 from a location remote from work machine 12. For example, system 10 may include a satellite 38 configured to receive data from work machine 12 and redirect it to a processing center 39 remote from work machine 12. Processing center 39 may be located at any distance or location relative to work machine 12.

Although various means and methods for offloading data from work machine 12 are described herein, these means and methods are exemplary only. The offloading of data from work machine 12 may be accomplished in any suitable manner with any suitable means for doing so.

Whether data is retrieved from work machine 12 via hardware interface device 18, over-the-air transmission receiving device 20, or some combination thereof, the retrieved data may be directed to a processor 40. Processor 40 may be integrated with hardware interface device 18 or may be located at processing center 39.

Data collection devices 14 may be configured to monitor operating parameters of work machine 12 in real-time. For purposes of this disclosure, the term “real-time” shall refer to the immediate or substantially immediate availability of data to an information system as a transaction or event occurs. That is, data may be retrieved and available for analysis as quickly as it can be transmitted from work machine 12 to processor 40. Such transmissions may be virtually instantaneous or may take a few seconds or minutes to complete.

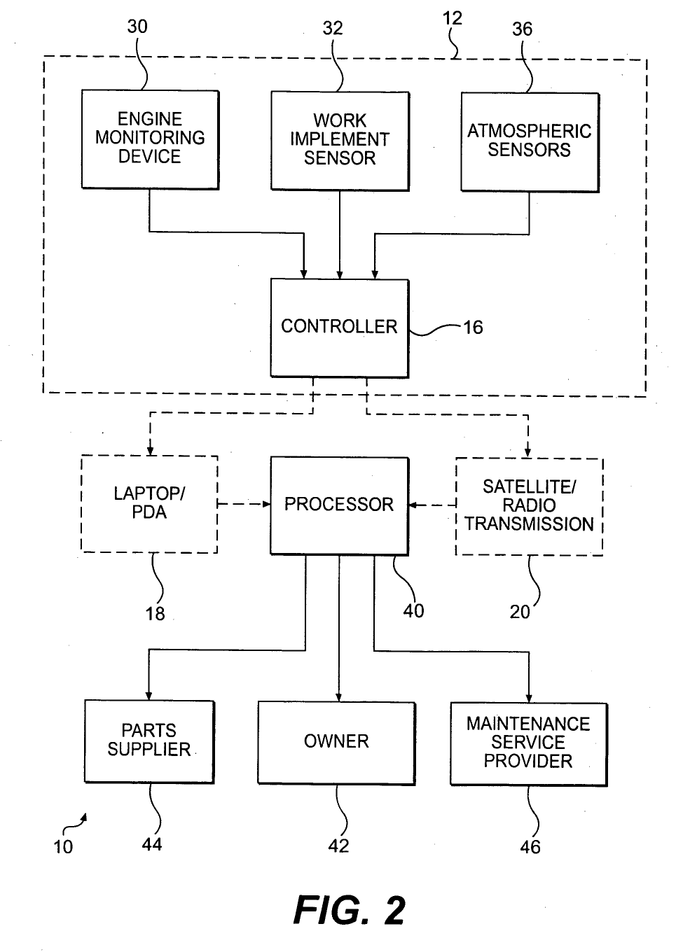

FIG. 2 is a block diagram representation of the flow of data through the various components of system 10. As illustrated by FIG. 2, data may be transmitted from various monitoring equipment, such as engine monitoring device 30, work implement sensor 32, and atmospheric sensors 36, to controller 16. The data may then be transmitted from controller 16 to processor 40 via either hardware interface device 18, over-the-air transmission receiving device 20, or some combination thereof. Processor 40 may analyze the data and/or make the data or analysis thereof available for consideration by one or more entities. For example, as illustrated in FIG. 2, the data and/or analysis may be forwarded to an owner 42 of work machine 12, a parts supplier 44, and/or a maintenance service provider 46. In some embodiments, system 10 may be configured to automatically make the data available to at least one entity other than owner 42.

Processor 40 may be configured to predict a cost to maintain work machine 12 in the future based on the data received from data collection devices 14. Processor 40 may be further configured to compare the predicted cost to maintain work machine 12 to a depreciated value of work machine 12 to determine a time for replacement of the work machine.

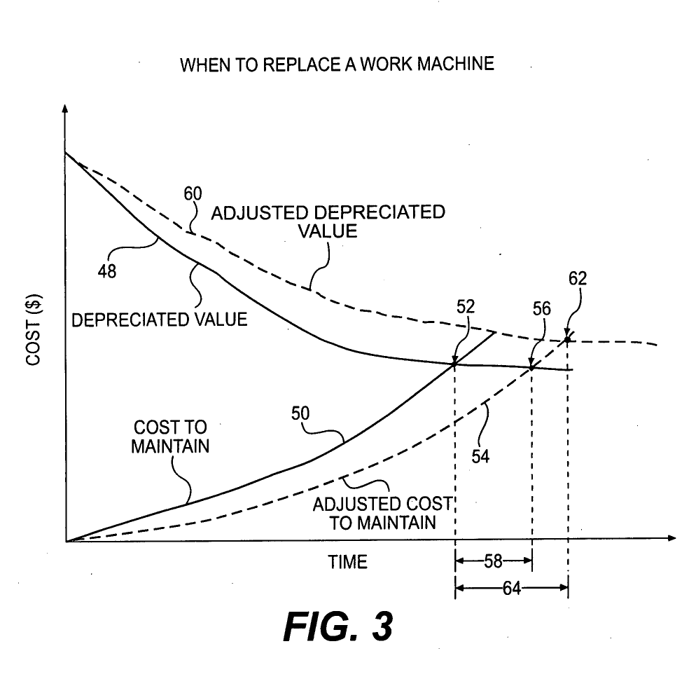

FIG. 3 is a graph illustrating the relationship between costs associated with ownership of work machine 12 (vertical axis) and time of ownership (horizontal axis). The depreciated value of work machine 12 is represented by a depreciated value line 48. Line 48 indicates depreciation in the value of work machine 12 over the course of a period of time. The depreciated value indicated by line 48 may include any type of value associated with work machine 12. For example, the depreciated value indicated by line 48 may include a market value of work machine 12. Such a market value may be based on one or more public sources of information which publish market values of new and/or used work machines either in print or electronically via the Internet or email (e.g., sometimes such published values are referred to as “book value”). Alternatively or additionally, depreciated values may be based, for example, on an owner's own proprietary database or other base of knowledge regarding depreciation of such work machines. An owner may also determine depreciation values based on other types of industry contacts and/or sources.

The costs to maintain work machine 12 are represented by a cost to maintain line 50. At an intersection point 52, depreciated value line 48 will cross cost to maintain line 50.

The crossing of these two curves over time represents the concept that when a piece of equipment is new, its value is high and the cost to maintain it is low, but as the equipment gets older, its value decreases until at some point the cost to maintain the equipment becomes higher than the depreciated value of the equipment. Barring other factors, the time when the depreciated value is the same as the cost to maintain is often the preferred time to replace work machine 12.

Cost to maintain line 50 may be based on a typical market average or other non-specific bases for predicting maintenance costs. Actual maintenance costs may be somewhat higher or lower than those represented by cost to maintain line 50 for a variety of reasons. For example, the amount and manner in which work machine 12 is used can have a significant effect on the cost to maintain work machine 12. A machine that has been operated for fewer hours and/or under less harsh conditions will typically require less maintenance and thus cost less to maintain. Such a situation is represented in FIG. 3 by an adjusted cost to maintain line 54.

By monitoring one or more operating parameters of work machine 12, a prediction of the future cost to maintain work machine 12 may be tailored to a specific work machine 12 (or fleet of work machines). Such a tailored prediction may be more accurate than a prediction that is not based on data retrieved from work machine 12. The cost to maintain curve may be adjusted to reflect increases or decreases in predicted maintenance costs as determined by the tailored prediction. Adjusted cost to maintain line 54 illustrates such an adjustment. Adjusted cost to maintain line 54 will often intersect depreciated value line 48 at a point other than intersection point 52, such as an intersection point 56.

A time span 58 between intersection point 52 and intersection point 56 may indicate a suggested adjustment in the preferred time to replace work machine 12. For example, processor 40 may determine from the data acquired from work machine 12 that work machine 12 was not or is not used very much and/or very hard. Thus, the owner may postpone replacement of work machine 12 for a period of time equal to time span 58. Postponing replacement as such may enable the owner to save money by waiting until a later date to incur potentially substantial upfront costs associated with purchasing a replacement machine.

The depreciated value represented by depreciated value line 48 may, in some embodiments, be predetermined, e.g., based on “book values.” In other embodiments, the depreciated value may be determined based on the data from data collection devices 14. For example, depreciated value line 48 may be predetermined based on market values of work machine 12 where the market values are established based on a certain value for a variable, such as engine hours (i.e., machines with a given amount of engine hours will have a predetermined market value).

However, data collection devices 14 may determine from acquired data that certain operating parameters indicate that many of the engine hours were spent idling. In such a case, the effect of the number of engine hours on the depreciated value of work machine 12 (i.e., more engine hours equals more depreciation) may be mitigated. That is, while excess engine hours may, according to public sources, result in a lower depreciated value, if many of those hours were spent idling, the depreciated value may not be quite as low because idling indicates a low load operating condition, which does not stress the work machine as much as high load conditions. Analysis of acquired data may provide for even more accurate predictions of depreciation, as well as future maintenance costs. In the illustrated example, the curve of depreciated value line 48 could be higher and thus the intersection of line 48 with adjusted cost to maintain line 54 may be pushed even further into the future. Conversely, line 48 could be lower and thus the intersection of line 48 with line 54 may be at an earlier time period.

It should also be noted that although the discussed/illustrated examples describe reductions in the predicted maintenance costs and increases in the time for replacement, the acquired data may also have the opposite effect on these two variables. That is, increased and/or more harsh use of work machine 12 could increase the predicted maintenance costs, thereby moving the preferred time to replace work machine 12 earlier rather than later.

In some embodiments, the depreciated value that is compared to predicted maintenance costs may include other measures of the value of work machine 12 besides “book value” or resale value. The depreciated value may include or may be based on one or more of a multitude of factors, such as, for example, the cost of a replacement machine, upfront costs such as down payment, service plans, extended warranty coverage, etc.

Additional factors may include availability of replacement machines, as well as whether the owner desires to replace the outgoing work machine with a new machine or a pre-owned machine. Further, if the owner plans on purchasing a pre-owned machine, an additional factor to be considered when determining the cost of replacement of work machine 12 may include how many years and/or for how many hours a potential replacement machine may have been in service. That is, how old of a machine is the owner willing to purchase as a replacement? An additional factor may include the trade-in (or resale) value of the machine that is being replaced. Some of these factors, such as trade-in value, may be based, at least in part, on the data acquired from work machine 12.

In some embodiments, owners may choose from several depreciated value curves corresponding to variations in the factors discussed above. For example, line 48 may indicate the depreciated value of a work machine having an average amount of engine hours. An owner may be able to choose from several sets of depreciated values corresponding to depreciation of a work machine with engine hours that are above average or below average. Adjusted depreciated value line 60 may indicate an increased depreciated value due to various types of acquired data. Adjusted depreciated value line 60 may intersect with adjusted cost to maintain line 54 at an intersection point 62. This would push the preferred time for replacement even further into the future (time span 64).

In some embodiments, owners may choose from several cost to maintain curves. An owner may choose from several curves corresponding to predetermined levels of maintenance. For example, one curve could be for cost to maintain with the minimum level of maintenance necessary to keep the work machine operational and/or meet warranty requirements (e.g., simply fixing problems as they arise). Another curve could be for an average level of maintenance, including, for example, regular oil changes, tune ups, etc. Another curve could be for a maximum level of maintenance including, for example, the most frequent maintenance intervals and component replacement at the earliest signs of wear.

The depreciated value of work machine 12 may include or may be based on productivity of work machine 12. Productivity may be a measure of, for example, the amount of revenue that work machine 12 is capable of generating for a given period of operation. Productivity may decline as a machine ages and/or wears out. In one embodiment, the comparison between depreciated value and projected maintenance costs may constitute a productivity/profitability analysis. In such an embodiment, all the costs of owning and operating work machine 12 (e.g., loan payments, fuel, maintenance, etc.) may be compared with the amount of revenue capable of being generated by work machine 12 for a given period of operation. The point in time at which owning and operating work machine 12 becomes no longer profitable may be a preferred time to replace work machine 12. In certain embodiments an owner may, for various reasons, prefer to replace work machine 12 somewhat before or after this point in time where work machine 12 becomes no-longer profitable. Data acquisition and analysis as described herein may enable an owner to better predict the depreciated value and/or the cost to maintain work machine 12. More accurate predictions of the depreciated value and/or the cost to maintain work machine 12 may facilitate more accurate productivity/profitability analysis.

In addition, the projected depreciated value of and/or the cost to maintain work machine 12 may be determined taking other factors into consideration. For example, maintenance history of work machine 12 may be considered as part of the determination. Such maintenance history may be collected and/or stored along with other data acquired regarding operating conditions of work machine 12. Component and/or system replacement, repair, overhaul, remanufacture, or any other type of service may be factors considered when determining the cost to maintain and/or the depreciated value of work machine 12. For example, data acquired as described above or in any other manner may indicate that while the overall machine has been in service for 20,000 hours, the engine was recently replaced and has 1000 hours. Having the new engine would, in most cases, reduce the projected cost to maintain work machine 12 and/or increase the depreciated value of work machine 12.

System 10 may be configured to suggest changes in operating conditions to one or more entities interested in work machine 12. For example, system 10 may be configured to suggest to an owner and/or operator changes in operating conditions that may have a positive impact on one or more aspects of machine operation. Such aspects may include productivity, operating expenses, longevity, etc. System 10 may be configured to suggest one or more preferred sets of operating conditions that may optimize the performance/efficiency and/or minimize wear and tear on work machine 12. For example, system 10 may be configured to recommend various types of maintenance (e.g., oil changes, component replacement, etc.) or operating parameters and/or techniques (e.g., how much throttle to use during particular tasks, proper tire pressure, etc.). System 10 may be configured to deliver such suggestions to owners, operators, and/or any other interested party in a variety of ways. The suggestions may be emailed to the interested parties or made available via a local or global webpage (e.g., the Internet). The suggestions may be delivered to processing center 39 and/or to work machine 12. For example, visual and/or audio alerts may be provided to an operator of work machine 12 that indicate via an on-board display/alert system (not shown) recommended operating parameters for optimizing various aspects of machine operation and/or longevity.

### INDUSTRIAL APPLICABILITY

The disclosed asset management system may be applicable for management of any kind of mechanical equipment asset for which operating data may be retrieved. For example, the disclosed system may be used for management of work machines, such as heavy duty equipment (e.g., excavators, track-type tractors, loaders, power generation sets, etc.) and/or light duty equipment (e.g., passenger vehicles, small-sized electric generators, lawn and garden tractors, etc.). Further, the disclosed system may be used to manage a fleet of one or more different types of work machines.

The disclosed system may be utilized for on-site monitoring of work machines at a worksite. Data may be retrieved and analyzed on location at the worksite. Alternatively or additionally, the disclosed system may be utilized for monitoring of work machines from a remote location. Data may be analyzed at a processing center remote from the work machine, such as a service or management center. For such remote analysis, the data may be retrieved on location at the worksite or delivered to processing center via a data transfer link (e.g., satellite communication).

The retrieved data may be examined by an individual (e.g., an owner, operator, service technician, rentor/renter, lessor/lessee, etc.) or by the disclosed system itself to monitor any of a number of operating parameters. The disclosed system may be utilized to process this data and predict an expected cost of future maintenance. The predicted expected cost of maintenance may be compared with a cost of replacement of the work machine to determine a time for replacement of the work machine.

An exemplary method of using the disclosed system may include determining a depreciated value of the work machine based on the retrieved data and comparing it to a projected cost to maintain the work machine to determine when to replace the work machine. The method may include choosing a set of values for at least one of the depreciated value and the cost to maintain the work machine. The disclosed system may also be used in offloading the data from the work machine and making the data available for consideration by one or more entities. This use of the system may involve automatically making the data available to at least one entity other than an owner of the work machine, for example a parts supplier or a maintenance service provider.

It will be apparent to those having ordinary skill in the art that various modifications and variations can be made to the disclosed asset management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. An asset management system, comprising:
one or more data collection devices configured to monitor one or more operating conditions of a work machine; and
a processor configured to:
receive data from the one or more data collection devices;
predict a cost to maintain the work machine in the future based on the data from the one or more data collection devices; and
compare the predicted cost to maintain the work machine to a depreciated value of the work machine to determine a time for replacement of the work machine.

2. The system of claim 1, wherein the one or more operating conditions includes operating parameters of the work machine.

3. The system of claim 1, wherein the one or more operating conditions includes at least two of the following:
operating parameters of the work machine;
geographic parameters; and
atmospheric conditions.

4. The system of claim 1, wherein the depreciated value of the work machine is a predetermined market value of the work machine.

5. The system of claim 1, wherein the depreciated value of the work machine is at least partially determined based on at least one of productivity and profitability of the work machine.

6. The system of claim 1, wherein more than one set of values for the depreciated value is available to be chosen.

7. The system of claim 1, wherein more than one set of values for the cost to maintain is available to be chosen, the more than one set being based, at least in part, on predetermined levels of maintenance.

8. The system of claim 1, wherein at least one of the cost to maintain and the depreciated value of the work machine are determined based on a maintenance history of the work machine.

9. The system of claim 1, wherein the system is configured to offload the data from the work machine and make the data available for consideration by one or more entities.

10. The system of claim 9, wherein the system is configured to automatically make the data available to at least one entity other than an owner of the work machine.

11. The system of claim 10, wherein the at least one entity includes a parts supplier.

12. The system of claim 10, wherein the at least one entity includes a maintenance service provider.

13. The system of claim 1, wherein the system is further configured to recommend at least one of maintenance, operating parameters, and operating techniques to an owner or operator of the work machine.

14. A method of determining a time for replacement of a work machine, comprising:
monitoring one or more operating conditions of the work machine;
collecting data for the one or more operating conditions;
predicting a cost to maintain the work machine in the future based on the collected data; and
comparing the predicted cost to maintain the work machine to a depreciated value of the work machine to determine a time for replacement of the work machine.

15. The method of claim 14, wherein the one or more operating conditions includes operating parameters of the work machine.

16. The method of claim 14, wherein the one or more operating conditions includes at least two of the following:
operating parameters of the work machine;
geographic parameters; and
atmospheric conditions.

17. The method of claim 14, wherein the depreciated value of the work machine is a predetermined market value of the work machine.

18. The method of claim 14, wherein the depreciated value of the work machine is at least partially determined based on at least one of productivity and profitability of the work machine.

19. The method of claim 14, further including choosing a set of values for the depreciated value from more than one set of values for the depreciated value.

20. The method of claim 14, further including choosing a set of values for the cost to maintain from more than one set of values for the cost to maintain, wherein the more than one set is based, at least in part, on predetermined levels of maintenance.

21. The method of claim 14, wherein the depreciated value of the work machine is predetermined.

22. The method of claim 14, further including determining the depreciated value of the work machine based on the data.

23. The method of claim 14, wherein at least one of the cost to maintain and the depreciated value of the work machine are predicted based on a maintenance history of the work machine.

24. The method of claim 14, further including offloading the data from the work machine and making the data available for consideration by one or more entities.

25. The method of claim 24, automatically making the data available to at least one entity other than an owner of the work machine.

26. The method of claim 25, wherein the at least one entity includes a parts supplier.

27. The method of claim 25, wherein the at least one entity includes a maintenance service provider.

28. The method of claim 14, further including recommending at least one of maintenance, operating parameters, and operating techniques to an owner or operator of the work machine.

29. A work machine, comprising:
a frame;
a power source mounted to the frame; and
an asset management system including:
one or more data collection devices configured to monitor one or more operating conditions of the work machine; and
a processor configured to:
receive data from the one or more data collection devices;
predict a cost to maintain the work machine in the future based on the data from the one or more data collection devices; and
compare the predicted cost to maintain the work machine to a depreciated value of the work machine to determine a time for replacement of the work machine;
wherein the system is configured to offload the data from the work machine and make the data available for consideration by one or more entities.

30. The work machine of claim 29, wherein the one or more operating conditions includes operating parameters of the work machine.

31. The work machine of claim 29, wherein the one or more operating conditions includes at least two of the following:
operating parameters of the work machine;
geographic parameters; and
atmospheric conditions.

32. The work machine of claim 29, wherein the depreciated value of the work machine is a predetermined market value of the work machine.

33. The work machine of claim 29, wherein the system is configured to automatically make the data available to at least one entity other than an owner of the work machine.
